(19) United States
(12) Patent Application Publication
(10) Pub. No.: US 2007/0090676 A1
(43) Pub. Date: Apr. 26, 2007

(54) GRAIN TRANSPORT TRAILER

(76) Inventor: Tracy M. White, LaFountaine, IN (US)

Correspondence Address: BARNES & THORNBURG LLP, 11 SOUTH MERIDIAN, INDIANAPOLIS, IN, 46204, US

(21) Appl. No.: 11/551,583

(22) Filed: Oct. 20, 2006

Related U.S. Application Data
(60) Provisional application No. 60/729,641, filed on Oct. 24, 2005.

(51) Int. Cl. B60P 1/56

(52) U.S. Cl. 298/8 H

(57) ABSTRACT

A grain transport trailer includes a frame having wheels secured thereto. A hopper is secured to the frame. The hopper has side walls arranged in a spaced-apart relationship to one another to define an interior region. The side walls are arranged to slope convergingly toward a discharge chute. A number of nozzles are coupled to the hopper and positioned to introduce high-pressure gas into the interior region.

This present application claims benefit of U.S. Provisional Patent Application Ser. No. 60/729,641, filed Oct. 24, 2005, which application is hereby incorporated by reference herein.

### BACKGROUND

The present disclosure relates to trailers, and in particular to trailers for holding or transporting particulate commodities such as grain. Trailers are widely used to hold and transport grain and other particulate commodities. Such trailers receive grain in an open-top hopper and dispense the grain though a discharge chute.

### SUMMARY

According to the present disclosure, a grain transport trailer includes a hopper and a nozzle to deliver a high-pressure gas into an interior region of the hopper. The nozzle delivers high-pressure gas to dislodge clustered grain particles or other particulate commodities contained in the hopper which may block the flow of grain particles out of the hopper by causing the grain to “hang-up” within the hopper.

In illustrative embodiments, the grain transport trailer includes a network of conduits positioned within the hopper. The conduits are arranged to deliver pressurized gas into the grain stored in the hopper to fragment any clusters of grain so that a smooth controlled flow of grain particles out of the grain transport trailer occurs.

Additional features of the present disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view showing a grain transport trailer having a grain hopper in accordance with the present disclosure;

FIG. 2 is a top plan view of the grain hopper of FIG. 1;

FIG. 3 is a cross sectional view of the grain hopper of FIG. 2 (note that the chute door has been removed for clarity of description);

FIG. 4 is an enlarged side elevation view showing the gas distribution conduit and the hopper (note that the nozzle is not shown in cross section for clarity of description); and

FIG. 5 is an enlarged, fragmentary view of the hopper showing the nozzle nesting within the nozzle housing (note that the nozzle is not shown in cross section for clarity of description).

### DETAILED DESCRIPTION

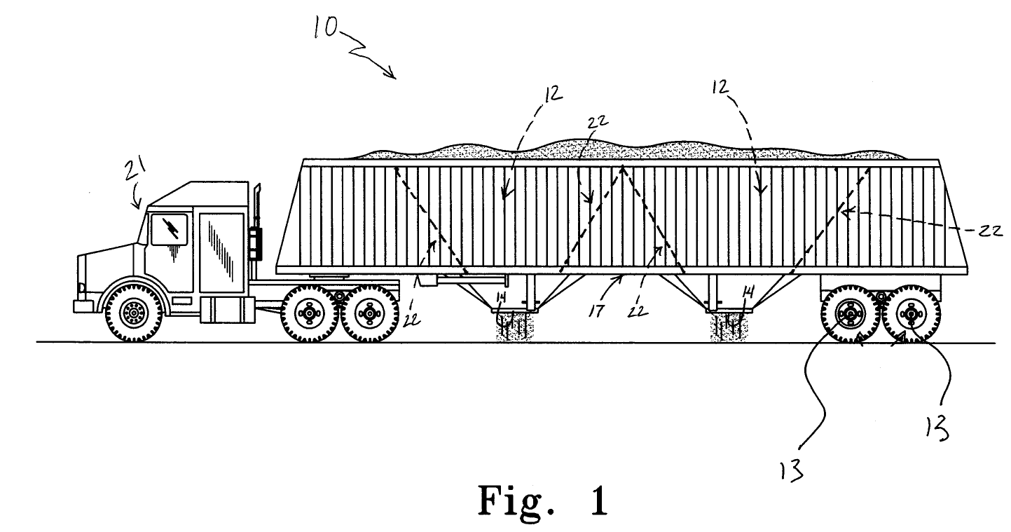

As shown in FIG. 1, a grain transport trailer 10 includes hoppers 12 secured to a frame 17. A number of ground engaging wheels 19 are secured to the frame via a pair of axles 13. A grain discharge chute 14 of the hopper depends from an underside of the frame 17. The grain transport trailer 10 is adapted to be coupled to a semi-tractor 21, as shown in FIG. 1. Illustratively, each of the hoppers 12 includes a number of side walls 22 arranged in a spaced-apart relationship to one another and coupled at a lower end to a grain discharge chute door 15 to define an interior region 24 therebetween.

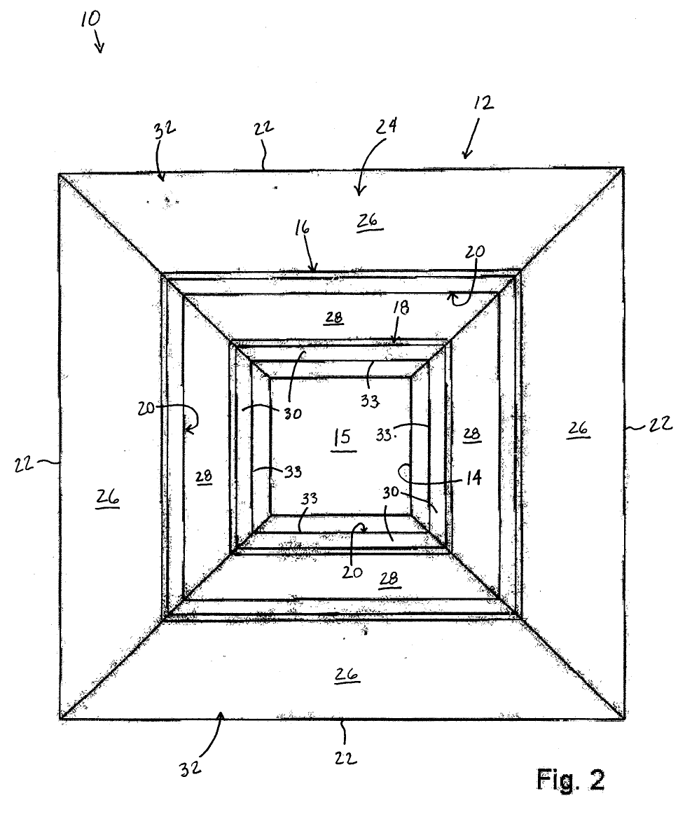

In the exemplary embodiment described herein, each side wall 22 includes a top segment 26, a middle segment 28, and a bottom segment 30 as shown in FIG. 2. The hopper 12 is generally funnel shaped. In other words, each side wall 22 is arranged to slope convergingly toward one another in the direction toward discharge chute 14. Discharge chute 14 is defined by lower edges 33 of bottom segments 30 and is positioned lower than grain-receiving opening 32. Discharge chute door 15 is coupled to hopper 12 in a conventional manner to pivot away from discharge chute 14 to allow, for example, grain or other particulate commodities to flow out of the hopper 12.

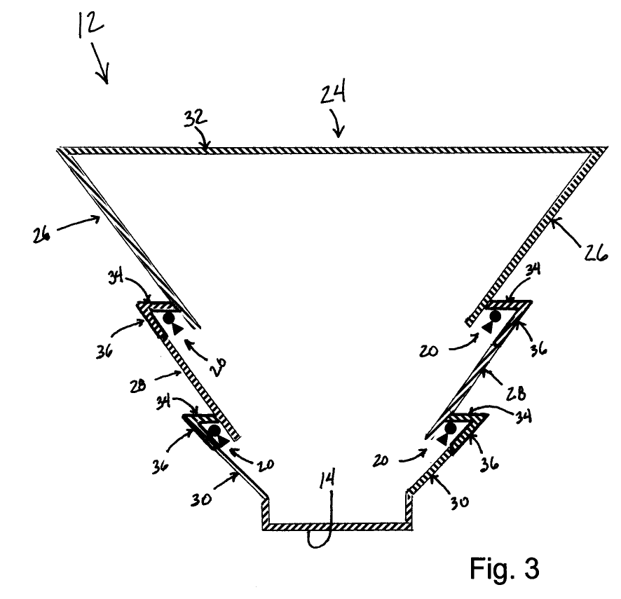

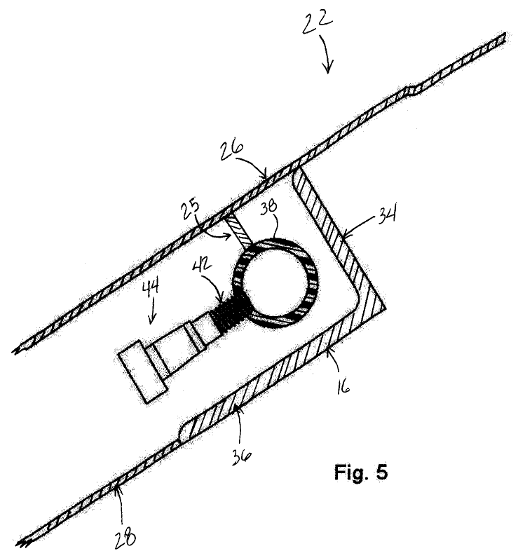

In an illustrative embodiment, an L-shaped nozzle housing 16 is coupled between top segments 26 and middle segments 28 of each side wall 22 to form a downwardly and inwardly-opening continuous channel around a lower edge of top segment 26, as shown best in FIG. 3. Nozzle housing 18 is similar to nozzle housing 16 in structure and function so that the description of nozzle housing 16 applies to nozzle housing 18 as well. Referring now to FIG. 5, nozzle housing 16 includes a first wall 34 secured in a perpendicular relationship to wall segment 26. A second wall 36 is secured to the first wall 34 and is positioned in a generally parallel relationship to wall segment 26. Second wall 36 is further coupled to an upper end of middle segment 28.

In a similar manner, second nozzle housing 18 is coupled between middle segments 28 and bottom segments 30 of each side wall 22 to form a downwardly and inwardly-opening continuous channel around a lower edge of middle segment 28, as shown in FIG. 3.

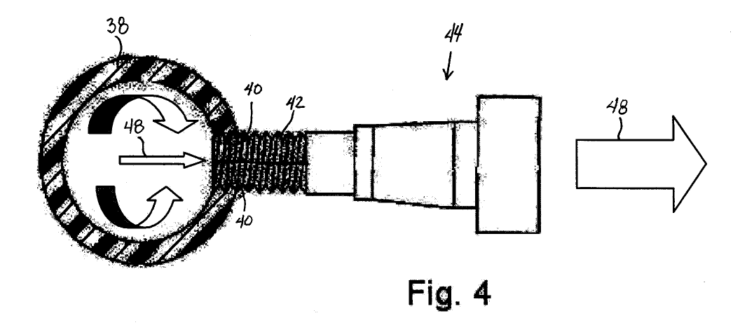

A gas distribution conduit 38 is positioned in each housing 16, 18. Referring now to FIG. 4, conduit 38 includes a number of apertures 40. Apertures 40 are threaded to receive the threaded connectors 42 of a number of nozzles 44 therein. Nozzles 44 are in fluid communication with conduit 38. Conduit 38 is coupled to side walls 22 with hanger brackets 25. In some embodiments, conduit 38 may be configured as a pipe having a plurality of perforations to allow the escape of high-pressure gas. Conduit 38 may be made of any suitable material to include steel, iron, plastic, or polyvinyl chloride.

In the illustrative embodiment, conduit 38 supplies pressurized gas 48 to nozzles 44 to deliver the pressurized gas 48 at adjustable angles into interior region 24. When hopper 12 is loaded with, for example, grain particles, moisture present in the atmosphere can cause the grain particles within the hopper 12 to agglomerate or “stick” to one another. When the user opens discharge chute door 15 to cause the grain particles to flow through discharge chute 14 and out of hopper 12, the agglomeration can cause the grain particles to “hang up” in the hopper and not flow downwardly and out of hopper 12 as desired.

Pressurized gas 48 flowing through conduits 38 causes a stream of high-velocity gas to flow out of nozzles 44 into hopper 12. This flow of high-velocity gas 48 out of nozzles 44 into the grain contained in the interior region will cause the sticking grain particles to separate and thus causes the agglomeration to fragment. When the agglomeration is fragmented, the grain is then able to flow downwardly through chute 14 and out of hopper 12 in a desired manner. In an illustrative embodiment, the pressurized gas 48 is ambient air. The high-velocity air may be provided by a pressurized air system of semi-tractor 21, or supplied by an independent air reservoir, or other storage means.

In some embodiments, conduit 38 may be formed by connecting several pivotable conduit segments. By pivoting a conduit segment 38, a user is able to independently change the direction of the nozzles 44 associated with the pivoted conduit segment 38 and thus change the direction of the gas expelled from nozzles 44.

Hopper 12 may be arranged to have a continuous annularly-shaped side wall 22, or a conically-shaped side wall 22. Additionally, hopper 12 may be configured to hold a number of different particulate commodities such as animal feed, plastic components, or other particle-type materials that may tend to agglomerate due to moisture when held in hopper 12. Hopper 12 may also be configured as a grain silo or other storage receptacle permanently mounted in a location.

In the illustrative embodiment, conduits 38 are arranged in a generally horizontal orientation with respect to hopper 12, but may be arranged in a generally vertical orientation, or in a combination of generally horizontal and generally vertical placements with respect to the grain-retaining region 24 of hopper 12. The conduits 38 could be used without nozzles. Apertures 40 would introduce the air stream into the hopper 12. Moreover, the nozzles 44 could be integrally formed with conduits 38.

1. A grain transport trailer comprising:
a frame having wheels secured thereto,
a hopper secured to the frame, the hopper having side walls arranged in a spaced-apart relationship to one another to define an interior region, the side walls arranged to slope convergingly toward a discharge chute, and
a number of nozzles coupled to the hopper and positioned to introduce high-pressure gas into the interior region.

2. The grain transport trailer of claim 1, further comprising a gas-supply conduit, wherein:
the hopper has a channel formed in the side walls, and
the gas-supply conduit and the nozzles are positioned in the channel.

3. The grain transport trailer of claim 1, wherein the nozzles are movable with respect to the hopper to adjust the direction of the high-pressure gas.

4. The grain transport trailer of claim 1, wherein the side walls include a top, a middle, and a bottom segment, further comprising:
a first channel positioned between the top segment and the middle segment, and
a second channel positioned between the middle segment and the bottom segment.

5. The grain transport trailer of claim 4, wherein:
a first plurality of the number of nozzles is positioned in the first channel, and
a second plurality of the number of nozzles is positioned in the second channel.

6. A grain transport trailer comprising:
a frame having wheels secured thereto,
a hopper secured to the frame having an interior region and a discharge chute to dispense grain particles, and
a number of nozzles coupled to the hopper and configured to introduce a number of streams of high-pressure gas into the interior region.

7. The grain transport trailer of claim 6, further comprising first and second channels formed in the hopper, wherein:
the channels are arranged to open inwardly toward the interior region,
a first plurality of the number of nozzles is positioned in the first channel, and
a second plurality of the number of nozzles is positioned in the second channel.

8. The grain transport trailer of claim 6, wherein the nozzles are movable with respect to the hopper to adjust the direction of the streams of high-pressure gas.

9. The grain transport trailer of claim 6, wherein the hopper includes a side wall having a top, a middle, and a bottom segment, further comprising:
a first channel positioned between the top segment and the middle segment, and
a second channel positioned between the middle segment and the bottom segment.

10. The grain transport trailer of claim 9, wherein:
a first plurality of the number of nozzles is positioned in the first channel, and
a second plurality of the number of nozzles is positioned in the second channel.

11. A particle storage apparatus comprising:
a receptacle having (i) a side wall defining an interior region, (ii) a discharge chute, and (iii) a channel formed in the receptacle opening inwardly toward the interior region,
a conduit positioned in the channel, and
a nozzle positioned in the channel, the nozzle being in fluid communication with the conduit and configured to direct a high-pressure air into the interior region.

12. The particle storage apparatus of claim 11, wherein the conduit is a perforated pipe.

13. The particle storage apparatus of claim 11, wherein the nozzles are movable with respect to the receptacle to adjust the direction of the high-pressure air into the interior region.

14. The particle storage apparatus of claim 11, wherein the conduit is coupled to an exterior surface of the receptacle.

15. The particle storage apparatus of claim 11, further comprising a frame having wheels secured thereto, wherein the receptacle is secured to the frame.
